(19) United States
(12) Patent Application Publication
(10) Pub. No.: US 2006/0169801 A1
(43) Pub. Date: Aug. 3, 2006

(54) Faucet side spray assembly

(76) Inventors: Chuanbao Zhu, Xiamen (CN); Xuedong Wang, Xiamen (CN); A'na Yan, Zhang Zhou (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/046,384

(22) Filed: Jan. 28, 2005

(51) Int. Cl. B05B 9/01; B05B 9/08; B05B 7/02

(52) U.S. Cl. 239/525; 239/526; 239/530

(57) ABSTRACT

A faucet side spray assembly, including a hand-held body. The hand-held body includes all of the functional elements of the faucet side spray assembly. The faucet side spray assembly further includes one or more ornamental elements, each of which may be removably secured to that hand-held body. The ornamental elements preferably include a pair of ornamental elements, that is, an ornamental spray head and an ornamental spray body. Preferably, each of the ornamental elements are secured to the hand-held body by sliding them onto and over the opposite ends of the hand-held body.

### TECHNICAL FIELD

The invention relates to faucet side spray assembly, and particularly to a faucet side spray assembly whose appearance can be readily changed by the interchange and replacement of one or more removable, ornamental elements.

### BACKGROUND OF THE INVENTION

Faucet side spray assemblies are well known in the art. For example, such side spray assemblies are taught and disclosed in patents that include U.S. Pat. Nos. 6,641,060 and 6,612,507.

Such faucet side spray assemblies are generally made of multiple internal parts. This is done so that when those parts are worn, they may be replaced. Such side spray assemblies may also be made of certain external, or at least partially externally visible, removable parts that serve a functional purpose. For example, the '507 patent includes a pulsation selector disc 50, a rotor disc 70, a selector disc 80, and an auxiliary cleaning attachment 100.

Notwithstanding these features, prior art faucet side spray assemblies are designed to a pre-determined and constant external appearance. Thus, if a manufacturer desires to make a faucet side spray assembly having a modern external appearance, that manufacturer must make a corresponding mold that will result in the appropriate shape. However, if a manufacturer desires to make a faucet side spray assembly having a more traditional external appearance, he must make a second, different mold that will result in this second shape.

As a result, a manufacturer of side spray assemblies must typically have different sets of tooling for each of the different ornamental designs that he sells. This is obviously costly. Additional expense is realized by the frequent need for a manufacturer to maintain a relatively large inventory of these many different styles.

While not directly pertinent to the present invention, other patents in this field include U.S. Pat. Nos. 6,301,727; 6,626,420; 6,464,265; 6,457,614; 6,360,770; 6,276,004; 6,249,921; 6,192,529; 6,170,098; 6,019,537; 5,803,120; 5,797,422; 5,779,146; 5,546,978; 5,396,929; 5,337,956; 5,199,639; 5,158,234; 5,027,851; 5,014,749; 4,821,960; 4,739,523; 4,735,357; 4,662,768; 4,272,022; 3,600,723; 3,131,868; and 302,022; and U.S. Patent Application Publication Nos. US 2003/0221254 A1, US 2004/0089752; US 2003/0140413; US 2003/0093857; US 2003/0001028; and US 2002/0053361.

The present invention is provided to solve the problems discussed above and other problems, and to provide advantages and aspects not provided by prior faucet side spray assemblies of this type. A full discussion of the features and advantages of the present invention appears in the following detailed description, and in the accompanying drawings.

### SUMMARY OF THE INVENTION

The new kitchen faucet side spray is comprised of a hand-held body; and at least one ornamental element that may be removably secured to that hand-held body. In a most preferred embodiment, two ornamental elements may be provided, including an ornamental spray head and an ornamental spray body.

The hand-held body houses all of the functional parts of the kitchen faucet side spray. By this, it is meant that the hand-held body can perform all of the functions of the faucet side spray assembly. Particularly, the hand-held body may include, but is not limited to, an internal water passage; a water valve that opens to permit water to pass through the internal water passage; and a handle that is pressed by the user, to open the water valve. In this way, the hand-held body is largely conventional, and typical of the general structure of other kitchen faucet side sprays.

At least one ornamental element, such as the ornamental spray head and the ornamental spray body, is secured to the hand-held body. While the ornamental element or elements may be secured by a variety of means, in this preferred embodiment, the ornamental element or elements are secured by sliding them over the opposite ends of the hand-held body. As noted above, the hand-held body includes all of the functional parts of the faucet side spray assembly, i.e., those parts that are responsible for receiving the water from a municipal water supply, transporting the water from the inlet of the faucet side spray assembly through that assembly, and for permitting the flow or restricting the flow of the water at the discharge end or nozzle of the faucet side spray assembly. Accordingly, the ornamental element or elements are purely ornamental, and have no function in dispensing or controlling the flow of water.

The ornamental spray head and the ornamental spray body are interchangeable. Specifically, a manufacturer can attach to the hand-held body any of an infinite number of spray heads and spray bodies, each having different ornamental appearances. By using different appearing spray heads and spray bodies on a common hand-held body, a manufacturer can quickly create kitchen faucet side spray assemblies having very different appearances.

It is, of course, possible to use any number of different appearing designs for the hand-held body. In this way, the use of a limited number of different appearing hand held bodies, along with one or more different appearing ornamental elements, can result in a large number of side spray assemblies, having entirely different styles or aesthetics.

Other features and advantages of the invention will be apparent from the following specification taken in conjunction with the following drawings.

### BRIEF DESCRIPTION OF THE DRAWINGS

To understand the present invention, it will now be described by way of example. The invention is being described with reference to the accompanying drawings, in which:

FIG. 1 is a perspective view of a preferred embodiment of the side spray assembly of the invention; and

FIG. 2 is a partially exploded perspective view of the side spray assembly of FIG. 1.

### DETAILED DESCRIPTION

While this invention is susceptible of embodiments in many different forms, there is shown in the drawings and will herein be described in detail preferred embodiments of the invention. The present disclosure is to be considered as an exemplification of the principles of the invention and is not intended to limit the broad aspect of the invention to the embodiments illustrated.

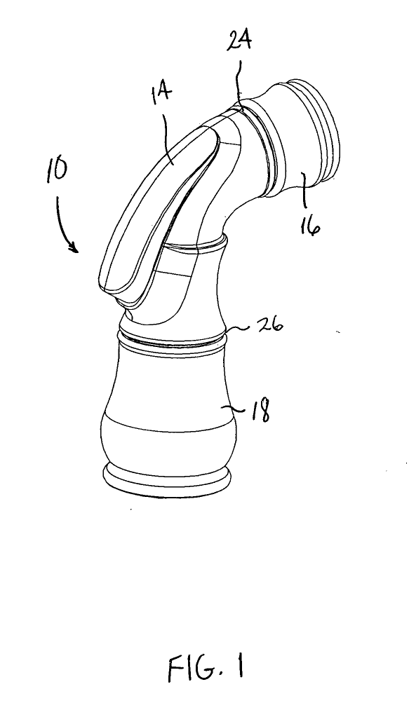

Referring now to FIG. 1, the invention is a faucet side spray assembly 10. The faucet side spray assembly 10 is largely conventional, and generally similar in structure and function to faucet side spray assemblies disclosed in other U.S. patents, including U.S. Pat. Nos. 6,641,060 and 6,612,507. These faucet side spray assemblies 10 and their components may be made of any suitable material, including but not limited to metals, plastics, rubber, and elastomers. These faucet side spray assemblies 10 may be mounted in many different environments, including but not limited to the top of a kitchen sink

Conventional kitchen faucets are secured to rigid, fixed municipal water supply conduits, typically made of plastics or metals. Such faucets are pivotable about a vertical axis, so that the faucet can be moved around an arc of approximately 150 to 180 degrees. In this way, the water stream from such a faucet may directed into either of the side-by-side twin sinks found in many kitchens. However, the faucets are not otherwise movable.

Prior art faucet side spray assemblies overcome these limitations. The water supply conduits to such assemblies are not rigidly fixed pipes, but are instead flexible rubber or metal braided hoses. One end of this flexible rubber or metal braided hose is secured to a rigid water supply pipe. The other end is secured to the inlet side of the faucet side spray assembly. The flexible rubber or metal braided hose has a relatively long length. That elongated length permits the user to pull that side spray assembly away from the top of the sink, permitting its use for spraying dishes and other eating utensils. When the user has finished his task with the side spray assembly, the flexible rubber or metal braided hose is returned to its storage position underneath the sink, and out of view. The side spray assembly is simultaneously returned to its storage position at the top of the sink.

While the present invention functions in the same way as the convention faucet side spray assemblies described above, the present invention also permits a single main component, the so-called hand-held body, to take on many different appearances, merely by virtue of the substitution of one or two or more different ornamental elements.

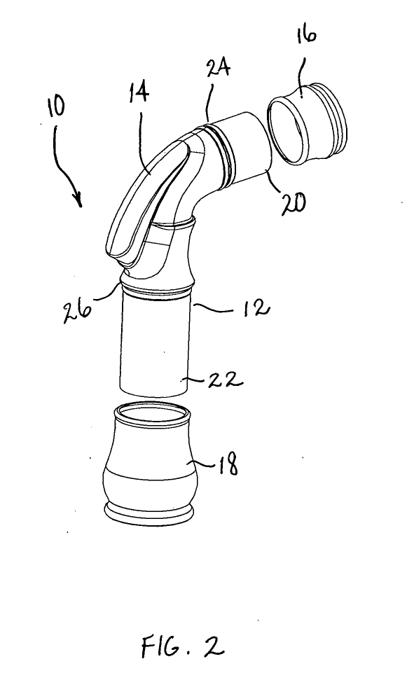

Referring now to FIG. 2, the present side spray assembly 10 is shown in a partially exploded form, with three exterior components. The first of these three exterior components is the hand-held body 12. This hand-held body 12 includes all of the components that control the flow of water through the side spray assembly 10, including but not limited to an exterior handle 14. This handle 14 is spring biased into the outwardly extending, normal position depicted in FIG. 2. When the user depresses this handle 14, a water flow control valve (not shown) positioned within the interior of the hand-held body 12 is opened, permitting pressurized municipal water to be discharged from the nozzle of the side spray assembly 10. When the user releases this handle, spring bias returns the handle 14 to the position shown in FIGS. 1 and 2. Simultaneously, the water flow control valve is closed, stopping the flow of water from the nozzle. Again, all of the functional elements of the faucet side spray assembly, that is, those components that permit the flow of water into, through, and out of the side spray assembly 10, are conventional, and are enclosed entirely within the hand-held body 12.

The invention further comprises at least one ornamental element, and can include two, three, four, five or even more ornamental elements. In fact, there is no practical limit on the possible number of ornamental elements that may be placed onto the hand-held body 12.

In this embodiment, two ornamental elements 16 and 18 are provided. The first of the two ornamental elements is the ornamental spray head 16. The second of the two ornamental elements is the ornamental spray body 18. The ornamental spray head 16 is normally secured to the discharge or nozzle end 20 of the hand-held body 12. The ornamental spray body 18 is normally secured to the inlet end 22 of the hand-held body 12.

As may be seen in FIG. 2, the two ornamental elements are removably secured to that hand-held body 12. The ornamental spray head 16 and the ornamental spray body 18, both of which are shown in FIG. 2, have an aesthetically traditional appearance. By replacing the ornamental spray head 16 and the ornamental spray body 18 of FIG. 2 with different appearing spray heads and spray bodies, the side spray assembly can take on an entirely different appearance. For example, different appearing spray heads and spray bodies can impart to the side spray assembly 10 of the invention a modern appearance, or an antique appearance, or one of any unlimited number of aesthetic appearances. In this way, a single hand-held body 12 can be modified to take on any number of different appearances.

The pair of ornamental elements, including the ornamental spray head 16 and the ornamental spray body 18, can be secured to the hand-held body 12 in any number of ways. By way of non-limiting examples, the ornamental elements can be secured to the hand-held body 12 with screws or other similar replaceable fasteners, or by complementary detents. Two of the detents will be formed in the surfaces of the hand-held body 12, at the nozzle end 20 and the inlet end 22. The other two complementary detents will be formed in the ornamental spray head 16 and the ornamental spray body 18, respectively.

In this case, the ornamental spray head 16 and ornamental spray body 18 are secured to the hand-held body 12 by virtue of a friction fit. The internal diameter of the ornamental spray head 16 is only slightly larger than the external diameter of the nozzle end 20 of the hand-held body 12. In addition, the internal diameter of the ornamental spray body 18 is only slightly larger than the external diameter of the inlet end 20 of the hand-held body 12. As a result of these dimensions, each of the ornamental elements 16 and 18 are retained upon the hand-held body 12 by virtue of this friction fit.

A manufacturer wishing to provide the side spray assembly 10 of FIGS. 1 and 2 with a different aesthetic appearance merely slides the ornamental spray head 16 and the ornamental spray body 18 off of the opposite nozzle end 20 and inlet end 22 of the hand-held body 12. Then, the manufacturer replaces ornamental spray head 16 and ornamental spray body 18 with a different appearing spray head 16 and spray body 18 (not shown).

In this embodiment, a pair of flanges 24 and 26 are formed upon the hand-held body 12. These flanges 24 and 26 act as a stop, and thus limit the sliding movement of the ornamental elements 14 and 16 upon the hand-held body 12.

While the specific embodiments have been illustrated and described, numerous modifications come to mind without significantly departing from the spirit of the invention. Thus, the scope of protection is only limited by the scope of the accompanying Claims.

What is claimed is:

1. A faucet side spray assembly, the side spray assembly comprising a hand-held body, said hand-held body including all of the functional elements of the faucet side spray assembly, and further comprising at least one ornamental element that may be removably secured to that hand-held body.

2. The faucet side spray assembly of claim 1, comprising a pair of ornamental elements that may be removably secured to that hand-held body.

3. The faucet side spray assembly of claim 2, wherein said pair of ornamental elements comprises an ornamental spray head and an ornamental spray body.

4. The faucet side spray assembly of claim 1, wherein each of said ornamental elements are secured to the hand-held body by sliding them onto the hand-held body.

5. The faucet side spray assembly of claim 2, wherein each of said ornamental elements are secured to the hand-held body by sliding them over the opposite ends of the hand-held body.

6. The faucet side spray assembly of claim 5, wherein each of said ornamental elements are retained upon the hand-held body by virtue of a friction fit.

7. The faucet side spray assembly of claim 5, further comprising a flange upon the hand-held body, for limiting the sliding movement of the ornamental elements along the hand-held body.

8. A faucet side spray assembly, the side spray assembly comprising a hand-held body, said hand-held body including all of the functional elements of the faucet side spray assembly, and further comprising a pair of ornamental elements that may be removably secured to that hand-held body.

9. The faucet side spray assembly of claim 8, wherein said pair of ornamental elements comprises an ornamental spray head and an ornamental spray body.

10. The faucet side spray assembly of claim 8, wherein each of said ornamental elements are secured to the hand-held body by sliding them onto the hand-held body.

11. The faucet side spray assembly of claim 9, wherein each of said ornamental elements are secured to the hand-held body by sliding them over the opposite ends of the hand-held body.

12. The faucet side spray assembly of claim 10, wherein each of said ornamental elements are retained upon the hand-held body by virtue of a friction fit.

13. The faucet side spray assembly of claim 10, further comprising a flange upon the hand-held body, for limiting the sliding movement of the ornamental elements along the hand-held body.

14. A faucet side spray assembly, the side spray assembly comprising a hand-held body, said hand-held body including all of the functional elements of the faucet side spray assembly, and further comprising at least a pair of ornamental elements that may be removably secured to that hand-held body, wherein said pair of ornamental elements comprises an ornamental spray head and an ornamental spray body, each of said ornamental elements being secured to the hand-held body by sliding them onto and over the opposite ends of the hand-held body, wherein each of said ornamental elements are retained upon the hand-held body by virtue of a friction fit, and further comprising a pair of flanges upon the hand-held body, for limiting the sliding movement of the ornamental elements along the hand-held body.
